(19) United States
(12) Patent Application Publication
(10) Pub. No.: US 2026/0145588 A1
(43) Pub. Date: May 28, 2026

(54) ADJUSTMENT MECHANISM FOR A MOTOR VEHICLE, AND METHOD FOR OPERATING SUCH AN ADJUSTMENT MECHANISM

(71) Applicant: Brose Fahrzeugteile SE & Co. Kommanditgesellschaft, Coburg, Coburg (DE)

(72) Inventors: Florian POHL, Ebersdorf (DE); Alexander CZEMPIK, Markkleeberg (DE)

(21) Appl. No.: 19/499,362

(22) PCT Filed: Jul. 8, 2024
(86) PCT No.: PCT/EP2024/069146

§ 371 Date: Jan. 5, 2026

(30) Foreign Application Priority Data
Jul. 10, 2023 (DE) 10 2023 206 542.8

(51) Int. Cl. B60N 2/02; B60N 2/06

(52) U.S. Cl. CPC B60N 2/02253; B60N 2/0248; B60N 2/067

(57) ABSTRACT

An adjustment mechanism for a motor vehicle, in particular for a vehicle seat, the adjustment mechanism having two actuating elements and an electric motor, by means of which the actuating elements can be adjusted relative to one another during operation, wherein, repeatedly during operation, at least one stored adjustment position of the actuating elements is moved to and/or a current adjustment position is assumed over a resting time. In the event of repeatedly moving to the stored adjustment position (P), a varying target position is moved to or, proceeding from the current adjustment position, a varying target position is moved to if the resting time exceeds a predefined duration. This means that the load on parts of the adjustment mechanism can be kept low.

The invention relates to an adjustment mechanism for a motor vehicle, in particular for a vehicle seat, and a method for operating such an adjustment mechanism.

A large number of electromotively adjustable adjustment mechanisms are installed in a motor vehicle. These include, for example, power windows, automatic (sliding) doors, convertible tops and, in particular, adjustment mechanisms for seat adjustment devices. A seat adjustment device can be a linear adjustment mechanism, for example for setting the longitudinal position of the seat, or a rotary adjustment mechanism, for example for setting the tilt of part of the seat.

In particular in the case of a seat, high forces, in particular also dynamic forces, can act on the adjustment mechanism during operation of the motor vehicle also as a result of the weight of the occupant, as a result of which the adjustment mechanism is subjected to a high load. Specifically when plastic parts are used, this can lead to high wear and, under certain circumstances, to premature failure.

In particular, such an adjustment mechanism often assumes defined adjustment positions, so that the load on the various components of the adjustment mechanism is high, specifically in this defined adjustment position. The defined adjustment position is, for example, a user-specific memory position into which the seat is moved. Often, a current adjustment position, once assumed, is maintained permanently or only rarely adjusted.

Based on this, the invention aims to keep the wear of an adjustment mechanism low in order to achieve a longer service life and/or to enable the use of more cost-effective materials or a less massive design of the adjustment mechanism and thus enable a cost-effective design.

The object is achieved according to the invention by an adjustment mechanism for a motor vehicle and by a method for operating a motor vehicle, wherein the adjustment mechanism comprises a control unit, at least two actuating elements and an electric motor by means of which the actuating elements are adjusted relative to one another during operation. The adjustment mechanism is designed in particular for a vehicle seat for seat adjustment and in particular for longitudinal adjustment.

The control unit is generally designed to actuate the electric motor and is configured in such a way that, during operation, the actuating elements repeatedly move to a defined adjustment position stored in the control unit. Such movement is also referred to as a position movement to a defined adjustment position. This stored adjustment position is in particular a memory position, i.e. an adjustment position that has been learned by the user and is thereby predefined. Alternatively, the stored adjustment position can be a fixed, predefined position, e.g., a (front) end position, for example, in the case of an easy-entry function (e.g., in a coupe or a third seat row). With such an easy-entry function, the seat can be subjected to load during the entry process, serving as a support/holding point.

The stored adjustment position is specifically saved in a memory of the control unit.

Alternatively or additionally to this operating situation of a stored adjustment position that is repeatedly moved to, in a further operating situation, a currently assumed adjustment position is maintained over a (longer) resting time; i.e., the current adjustment position is not adjusted during the resting time.

In order to keep the load and thus the wear on certain parts of the adjustment mechanism low, specifically on drive elements through which the adjustment is carried out, the control unit is now configured so that, when the stored adjustment position is repeatedly moved to, a varying target position is moved to. That is, the adjustment position actually moved to, referred to here as the target position, does not (necessarily) correspond to the stored adjustment position, but deviates from it. During the course of repetitions, one of the different target positions can also correspond to the actual adjustment position. Thus, by means of the control unit, for at least a large proportion of the adjustment operations, a target position different from the adjustment position is moved to on a targeted basis.

In the case of the operating situation of a permanent adjustment position, in which the current adjustment position remains unchanged over a resting time, the control unit is configured in such a way that, proceeding from this fixed adjustment position, a target position different therefrom is moved to when the resting time exceeds a predefined duration. This target position is also referred to as a varying target position, since this target position is selected from a variety of different target positions.

In this case, the predefined duration is stored, in particular, in a memory specifically within the control unit. The control unit is preferably configured to check the resting time in the current adjustment position, and in particular whether the predefined duration is exceeded. Each time an actual target position is moved to (which then defines the current adjustment position), the resting time is reset to zero. This ensures that the current adjustment position is in any case automatically changed after a predefined duration.

A varying target position is generally understood to mean that a plurality of target positions, in particular at least 3 and preferably more than 5 or more than 10, are possible, which are also moved to over time. The adjustment mechanism remains in this target position thus assumed, which defines a current adjustment position, until the next adjustment operation initiated by the user (directly or indirectly) or until the predefined duration is exceeded again.

This measure involving the deliberate movement to different target positions results in the adjustment mechanism actually assuming different positions despite the same set adjustment position. This results in different regions of the adjustment mechanism being loaded for the desired, stored adjustment position. Over the operating time, the load is therefore distributed across a plurality of regions of the adjustment mechanism. This means that wear is distributed across a plurality of regions, so that, as a whole, the service life is increased and/or less expensive materials and/or structurally less massive designs of the adjustment mechanism can be used.

This embodiment is based in particular on the consideration that increasingly high-precision electric motors are used for such adjustment mechanisms, namely specifically brushless DC motors, which are characterized by their very high, recurring adjustment accuracy. A set, predefined and stored adjustment position is repeatedly moved to with such high accuracy that the same regions of the adjustment mechanism always engage in the defined adjustment position and are thus loaded. This problem typically does not arise in conventional adjustment mechanisms due to higher tolerances.

In a preferred embodiment, a fluctuation range is specified; i.e., a defined value for the fluctuation range is stored, in particular, in the control unit. The various target positions lie within this fluctuation range. The term fluctuation range is generally understood to mean the adjustment range of the adjustment mechanism around the defined, stored adjustment position. In particular, the fluctuation range is defined by the adjustment position plus/minus half of the fluctuation range.

The fluctuation range is preferably set to a value so small that a user does not perceive the deviation of the actual target position from the adjustment position.

In a preferred embodiment, the fluctuation range is further set in such a way that it is sufficiently large so that the assumed adjustment positions differ in such a way that different parts of the adjustment mechanism are loaded in these positions, so that the load is distributed.

Specifically, the fluctuation range for a linear adjustment of the actuating elements is selected in such a way that it is in the range of 0.1 mm to 5 mm and preferably up to a maximum of 1 mm or even up to a maximum of 0.5 mm. The fluctuation range is usually smaller for height adjustment than for longitudinal adjustment (for example, by a factor of 2 or more). In the case of angular adjustment, in which the two actuating elements are pivoted or rotated relative to one another about, for example, a common pivot axis, the fluctuation range preferably lies between 0.5° and 3°, in particular between 1° and 2°.

In the case of linear adjustment, in particular longitudinal adjustment, the two actuating elements are, in particular, two elements that are linearly displaceable relative to one another, specifically telescopically extendable elements and/or two rails. Specifically, these two actuating elements are an upper rail and a lower rail of the vehicle seat. The predefined fluctuation range defines, in particular, an actual travel path of the component to be adjusted, for example of a seat part relative to a floor. In the case of angular adjustment, this is the actual tilt adjustment of the component, for example of the backrest part relative to the seat part or of the seat part relative to the floor, etc. The component to be adjusted may generally be a part of the vehicle seat with which the user comes into direct contact. Accordingly, the adjustment mechanism is generally intended for adjusting such a component.

In a preferred embodiment, the particular current target position to be moved to is determined by a predefined selection method, for example based on a stored table or based on an algorithm that selects the target positions, for example randomly or pseudorandomly. The selection method is stored in the control unit. As a result, it is ensured that as many different target positions as possible are moved to and that overall a uniform load distribution is achieved.

In a preferred further development, the target positions reached are captured and saved, preferably in a so-called histogram. In a preferred further development, the target position to be used in the future is determined based on the saved historical data on the previous target positions. This selection logic is, in particular, part of the previously mentioned selection method. The historical data or the histogram are preferably stored in a memory that is in particular assigned to the control unit or is part of it and is thus part of the control unit as a whole. Selection based on the historical data is carried out in particular in such a way that the different target positions are moved to uniformly over the operating time.

With regard to the predefined duration, upon the exceeding of which a varying target position is moved to from the permanent adjustment position, a value for this duration is in particular defined and stored in the control unit, specifically in a memory. This value is preferably fixed and unchangeable, or alternatively at least parameterizable at the factory.

The resting time, which is compared with the predefined duration, is, for example, an accumulated operating time of the motor vehicle, for example the accumulated time during which the ignition is switched on. Alternatively, the number of ignition operations (activation of the ignition) or another value characteristic of the actual use of the motor vehicle can be used as a measure of the duration/resting time.

Preferably, the control unit is designed to capture the resting time and comprises, for example, a timing element that captures the operating time or a counting element that accumulates the ignition operations. Timing elements and counting elements are understood to mean electronic circuits designed to capture the operating time or the number of ignition operations.

Preferably, the resting time during which the adjustment mechanism is located in a defined target position is captured and in particular saved, specifically as part of the histogram mentioned above. This therefore includes the number, preferably supplemented by the duration of time, during which the adjustment mechanism was in a defined target position. The selection of future target positions is then preferably carried out in such a way that a uniform resting time for the different target positions is achieved.

In a preferred embodiment, the adjustment mechanism comprises a spindle drive. In general, the adjustment mechanism comprises in particular a plurality of drive elements that engage with one another via a toothing, specifically a spindle nut and a worm gear. The varying target positions are now selected in such a way that, in the different target positions, different teeth of the drive elements engage with one another. This ensures that the load is distributed over different teeth or tooth combinations of the two drive elements. Specifically, the target positions are selected in such a way that it is ensured that different teeth are loaded for both drive elements.

According to a preferred further development, the adjustment mechanism comprises a multi-stage gearbox having more than two toothed drive elements that engage via a toothing, and the varying target positions are selected in such a way that, in the different target positions, different teeth engage with one another for all drive elements, or that each drive element assumes a different rotational position in the different target positions. Therefore, different teeth are loaded on all drive elements for the different target positions. This embodiment is based on the consideration that, despite different target positions, an identical tooth can be loaded on at least one drive element. This is prevented by the measure described above.

Preferably, different target positions that meet this condition are stored in the control unit, for example in a table and/or a histogram.

Expediently, the fluctuation range is selected such that it corresponds to a predefined tooth offset. Tooth offset is understood to mean the number of teeth that may be assumed for the different target positions within the predefined fluctuation range. Therefore, a fixed value for this tooth offset is defined and stored in the control unit. This value is preferably a maximum of 10 or a maximum of 5 teeth.

A brushless DC motor is preferably used as the electric motor. With such a motor, highly precise movement to the different target positions, and thus their deliberate variation, is readily possible. The adjustment mechanism is preferably part of a vehicle seat.

The control unit is, for example, a control unit integrated into the vehicle seat. The control unit is also directly integrated into the electric motor, meaning it forms a structural unit with the electric motor.

Alternatively or additionally, it is also possible in principle to use a remote, for example higher-level, control unit.

Where reference is made herein to a control unit, this is preferably a (single) structural unit that is designed to perform the described steps. In principle, the control unit can also be divided into a plurality of physical structural units, via which the described steps are then carried out.

An exemplary embodiment of the invention is explained in greater detail below with reference to the figures. In the figures,

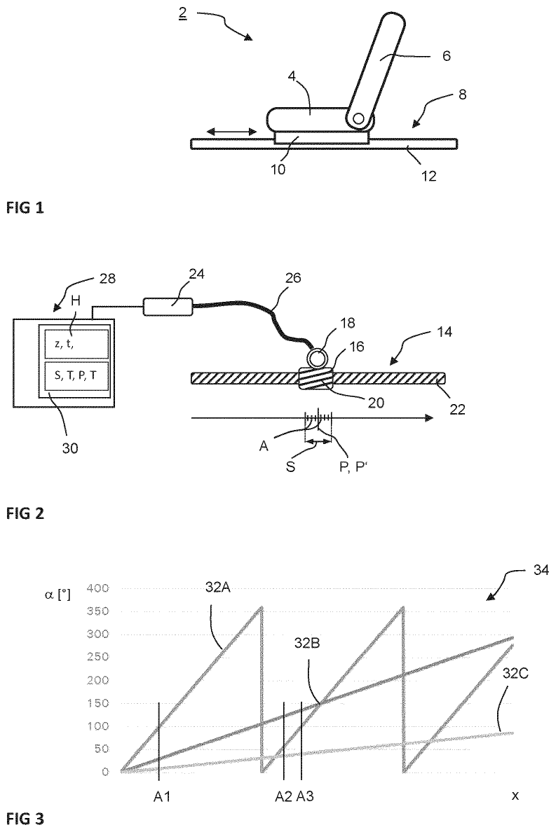

FIG. 1 shows a highly simplified side view of a vehicle seat having an adjustment mechanism for longitudinal adjustment,

FIG. 2 shows a highly simplified schematic representation of an adjustment mechanism having an associated control unit and

FIG. 3 shows a schematic representation of a multi-stage gearbox having different angular positions of the various drive elements.

A vehicle seat 2 shown in FIG. 1 comprises a seat part 4 and a backrest part 6, which are pivotably mounted relative to one another. The seat part 4 is connected to a vehicle floor (not shown in further detail here) so as to be longitudinally adjustable by means of an adjustment mechanism 8 via a rail system. This comprises, as actuating elements of the adjustment mechanism 8, an upper rail 10 and a lower rail 12, which are electromotively adjustable relative to one another in accordance with the double arrow.

The operation of the adjustment mechanism 8 is illustrated below based on such a seat longitudinal adjustment, but is not limited thereto. The adjustment operations and adjustment principles explained below can in principle also be transferred to other adjustment mechanisms, in particular also to a tilt adjustment of the seat part 4 relative to, for example, the vehicle floor, to a tilt adjustment of the backrest part 6 relative to the seat part 4, or also to other adjustment mechanisms, for example in window regulators, doors, etc.

Electromotive adjustment mechanisms 8 frequently comprise a spindle drive 14, as shown by way of example in FIG. 2. This regularly comprises, as a first drive element, a spindle nut 16, which is set in rotation by a worm gear 18 as a further drive element. In particular, the worm gear 18 engages in a toothing of the spindle nut 16, which comprises a plurality of teeth 20. In the exemplary embodiment, a situation is shown in which the toothing is an external toothing. The spindle nut 16 in turn typically drives a spindle rod 22. The relative movement thereby generated between the spindle nut 16 and the spindle rod 22 is transferred in a suitable manner to the two rails 10, 12. In addition to such spindle drives 14, other drive mechanisms can also be selected, in which likewise two drive elements, for example a rack and a pinion or two gears, etc., engage with one another via a toothing.

The worm gear 18 is generally driven by an electric motor 24, in particular a brushless DC motor. For this purpose, a shaft 26, in particular a (bending) flexible shaft, is typically used, which connects the electric motor 24 to the worm gear 18. The bending flexibility of the shaft 26 is illustrated by the curved line in FIG. 2.

The operation of the electric motor 24 and in particular also of the entire adjustment mechanism 8 is controlled by means of a control unit 28. This is shown in FIG. 2 as a separate logical unit. For example, it forms a common integrated structural unit with the electric motor 24; i.e., the control unit 28 is integrated within a common housing of the electric motor 24. The control unit 28 and/or the electric motor 24 are in particular integrated in the vehicle seat 2.

The control unit 28 generally comprises a computing element, such as a microprocessor, an IC, an ASIC or another suitable electronic component or component group. Furthermore, the control unit 28 comprises a memory 30.

The electromotive seat adjustment and thus also the control unit 28 can typically be set by the user to the extent that one or more defined adjustment positions, also referred to as memory positions, are stored and saved in the memory 30. Such memory positions can then be repeatedly moved to, in particular under user control, by means of an operating command.

Such a memory position simultaneously defines a predefined adjustment position P, which is thus stored in memory 30.

Repeated movement to this stored adjustment position P or also remaining for too long in this selected adjustment position P or in another current adjustment position P′ would lead to excessive load of certain teeth 20 of the spindle drive 14.

In order to avoid this, a fluctuation range S is predefined around the stored adjustment position P, within which a plurality of different actual target positions A can be assumed.

When a repeated movement to the stored adjustment position P is desired, for example due to a user request, the control unit 28 now controls the electric motor 24 in such a way that—when specifying that the stored adjustment position P is to be moved to—an actual target position A is moved to. This is selected from a plurality of target positions A that are within the fluctuation range S. One of the target positions A is the stored adjustment position P.

As a result, the loads on the different teeth 20 are distributed, so that overall a longer service life is achieved or, alternatively, a less massive design of the teeth 20 and overall of the spindle drive 14 can be implemented, whereby cost savings are achieved.

In many operating situations, the current adjustment position P′, which can be a stored adjustment position P, is left unchanged by the user over a long period of time, for example when user changes occur infrequently. In order to distribute the load over a plurality of teeth 20 even in such situations, the control unit 28 automatically initiates an adjustment from the current adjustment position P′ to a target position A that differs therefrom and varies, as soon as a resting time t exceeds a predefined duration T, which is in particular stored in the control unit 28.

The value for the duration T along with the value for the fluctuation range S are stored in the memory 30, for example as a predefined parameter set, either as fixed values or as parameterizable values.

In order to ensure the most uniform possible load distribution, the control unit 28 is designed to capture historical data during the operation of the adjustment mechanism 8. Specifically, the control unit 28 is designed, for example by means of suitable sensors or evaluation circuits, to capture a number z indicating how often a particular target position A is actually moved to over time. Additionally or alternatively, the control unit 28 is designed to capture and in particular to accumulate the resting time t during which a particular target position A is actually assumed. The number z and/or the accumulated resting time are preferably stored. For this purpose, a so-called histogram H, for example in the form of a table, is stored. For each target position A, an (accumulated) number z and/or an accumulated resting time are therefore saved and stored.

The actuation and specification of the target position A currently to be moved to are carried out by the control unit 28 according to a predefined, stored selection method. Here, the stored data relating to the number z and/or the accumulated resting times are in particular also taken into account, in such a way that the most uniform possible distribution of the numbers z and/or the accumulated resting times of the different target positions A, and thus of the load, is achieved.

The control unit 28 is in particular also designed for continuous monitoring of whether the resting time t during which the adjustment mechanism 8 remains unchanged in the current adjustment position P′ reaches the predefined duration T. In this case, an adjustment to a target position A that differs from the current adjustment position P′ is initiated.

FIG. 3 additionally shows another situation of a multi-stage gearbox 34, in which more than two and, in the exemplary embodiment, three mutually meshing drive elements 32A-32C (gears) engage with one another. A circumferential angle α is plotted for each drive element 32A-32C relative to an adjustment position x. Due to the transmission ratio of the gearbox 34, the drive elements 32A-32C rotate at different speeds.

The drive element 32A is, for example, the (motor or drive) shaft 32, the drive element 32B is an intermediate stage, also referred to as an intermediate stage, and the drive element 32C is the spindle nut 16.

Three target positions A1, A2, A3 are shown, which satisfy the condition described above that they lie within the fluctuation range S.

However, in the target positions A1 and A3, the circumferential angle α for the first drive element 32A is identical, so that the same circumferential region and thus the same tooth is loaded in both target positions A1, A3.

The target positions A are now preferably selected such that, for each target position A, different teeth are loaded in each of the drive elements 32A-32C. This condition is satisfied in the target positions A1 and A2. In these target positions, each individual drive element 32A-32C has different circumferential angles a in the two target positions A1 and A2. As a result, it is avoided that, for different target positions A, the same tooth is loaded on one of the drive elements 32A-32C.

Thus, in the exemplary embodiment, the circumferential angles α for the three drive elements 32A-32C are thus
for target position A1: 100°/29.4°/8.65°,
for target position A2: 50°/120°/35.5°, and
for target position A3: 100°/135°/39.8°.

Preferably, the possible target positions that satisfy the condition that different teeth are loaded for each drive element 32A-32C in the different target positions A are stored, for example in a table. The selection of the different, varying target positions A is carried out in particular as described above and is captured, for example, in a histogram. This means that, overall, a load that is as uniform as possible on all drive elements 32A-32C is ensured.

### LIST OF REFERENCE SIGNS

2 Vehicle seat
4 Seat part
6 Backrest
8 Adjustment mechanism
10 Upper rail
12 Lower rail
14 Spindle drive
16 Spindle nut
18 Worm gear
20 Teeth
22 Spindle rod
24 Electric motor
26 Shaft
28 Control unit
30 Memory
32A-C Drive element
34 Gearbox
P Stored adjustment position
P′ Current adjustment position
A Target position
S Fluctuation range
H Histogram
T Resting time
T Predefined duration
z Number
α Circumferential angle
x Adjustment position

1. An adjustment mechanism for a motor vehicle, comprising a control unit, two actuating elements and an electric motor, by means of which the actuating elements are adjusted relative to one another during operation, wherein the control unit is designed to actuate the electric motor and is configured in such a way that, repeatedly during operation, at least one stored adjustment position of the actuating elements is moved to and/or wherein a current adjustment position is assumed over a resting time characterized in that the control unit is configured such that, in the event of repeatedly moving to the stored adjustment position, a varying target position is moved to or, proceeding from the current adjustment position, a varying target position is moved to if the resting time exceeds a predefined duration.

2. The adjustment mechanism according to claim 1, wherein a fluctuation range around the stored adjustment position is predefined and that the target position lies within the fluctuation range.

3. The adjustment mechanism according claim 1, wherein the fluctuation range is set to such a small value that a user does not perceive the deviation of the actual target position from the stored adjustment position.

4. The adjustment mechanism according to claim 1, wherein the fluctuation range is in the range of 0.1 mm to 5 mm for a linear adjustment and in the range of 0.5° to 3° for an angular adjustment.

5. The adjustment mechanism according to claim 1, wherein a selection method is stored in the control unit, based on which the target position currently to be moved to is determined.

6. The adjustment mechanism according to claim 1, wherein the control unit is designed to store the particular target positions actually moved to and the selection for future target positions is made based on this saved data.

7. The adjustment mechanism according to claim 1, wherein the control unit is designed to capture a resting time during which no adjustment is carried out, wherein an accumulated resting time is preferably captured and stored for each target position.

8. The adjustment mechanism according to claim 1, wherein it comprises a spindle drive.

9. The adjustment mechanism according to claim 1 further comprises a plurality of drive elements that engage with one another via a toothing, in particular a spindle nut and a worm gear, wherein the varying target positions are selected in such a way that different teeth of the drive elements engage with one another in the different target positions, wherein the fluctuation range corresponds to a predefined tooth offset of, for example, a maximum of 10 or a maximum of 5 teeth.

10. The adjustment mechanism according to claim 1 further comprises a multi-stage gearbox with more than two toothed drive elements that engage via a toothing, wherein the varying target positions are selected in such a way that, in the different target positions, different teeth engage with one another for all drive elements.

11. The adjustment mechanism according to claim 1, wherein the electric motor is designed as a brushless DC motor.

12. The adjustment mechanism according to claim 1 is part of a vehicle seat.

13. A method for operating an adjustment mechanism for a motor vehicle, in particular for adjusting a vehicle seat, in which two actuating elements are adjusted relative to one another by means of an electric motor, wherein, repeatedly during operation, at least one stored adjustment position of the actuating elements is moved to and/or wherein a current adjustment position is assumed over a resting time, characterized in that, in the event of repeatedly moving to the stored adjustment position (P), a varying target position is moved to or that, proceeding from the current adjustment position, a varying target position is moved to if the resting time exceeds a predefined duration.
